(19) United States
(12) Patent Application Publication
(10) Pub. No.: US 2025/0296219 A1
(43) Pub. Date: Sep. 25, 2025

(54) WORKING APPARATUS HAVING A TRANSPORTABLE TRESTLE

(71) Applicant: FESTOOL GMBH, Wendlingen (DE)

(72) Inventor: Timo BAYER, Tübingen (DE)

(21) Appl. No.: 18/861,013

(22) PCT Filed: Apr. 3, 2023
(86) PCT No.: PCT/EP2023/058641

§ 371 Date: Oct. 28, 2024

(30) Foreign Application Priority Data
Apr. 27, 2022 (DE) 10 2022 110 147.9

(51) Int. Cl. B25H 1/06; B25H 1/16; B27B 21/00; F16M 11/32

(52) U.S. Cl. CPC B25H 1/06; B25H 1/16; B27B 21/00; F16M 11/32

(57) ABSTRACT

A working apparatus that has a work trestle that can adopt a working configuration for its intended use and a transport configuration for its transportation. The work trestle has a support body suitable for placing objects and support leg structures arranged in a positionally variable manner on the support body. The transport of the work trestle is facilitated by a transport container with a carrying handle which may either be a separate component in relation to the work trestle or form an integral part of the work trestle as the support body.

The invention relates to a working apparatus having a transportable work trestle, wherein the work trestle has a support body defining an object support surface that extends in a longitudinal trestle direction, and two support leg structures that are mounted, or can be mounted, in a positionally variable manner on the support body at leg attachment interfaces arranged spaced apart from one another in the longitudinal direction of work trestle,

and wherein the work trestle can optionally be brought into a working configuration that allows for its intended use, with the support leg structures extending transversely to the longitudinal trestle direction of the support body in a usage position or in a transport configuration intended for transporting the work trestle, with the support leg structures moved into a non-usage position adjacent to the support body.

A working apparatus of this type known from US 2007/0131306 A1 includes a work trestle with a beam-like structured support body and two support leg structures each consisting of two support legs, which are pivotably mounted on the support body at leg attachment interfaces arranged spaced apart from one another in the longitudinal trestle direction. The support leg structures can be positioned in a usage position folded away from the support body, which defines a working configuration of the work trestle, in which the trestle, placed on any floor surface, can be used for tasks where objects to be worked on can be placed on an upward-facing object support surface of the support body. The object could be, for example, a workpiece to be processed by means of a machine. For simplified transport between different usage locations, the work trestle can be reconfigured into a transport configuration by folding the support leg structures into a non-usage position adjacent to the support body. A handle may be attached to the support body. Extendable extension arms can be used to enlarge the object support surface of the work trestle.

The U.S. Pat. No. 4,155,386 discloses a collapsible workbench with two wooden plates defining a working surface and two support leg structures mounted on the wooden plates and spaced apart from one another. Each support leg structure has two support legs that can be pivoted relative to one another and can be fixed in a spread-apart position.

It is known from EP 2 450 156 B1 that foldable sawhorses can be equipped with a securing mechanism that allows the two sawhorses to be coupled together for joint transport.

EP 0 555 533 B1 discloses a stackable case that can be used as a transport container, equipped with a coupling system that enables multiple cases stacked on top of one another to be detachably connected to one another to form a unified, transportable stacked assembly.

The invention is based on the object of providing a working apparatus equipped with a transportable work trestle that is space-saving and easy to transport by hand.

To achieve this object, it is provided that, in a working apparatus with the features mentioned at the beginning, the support body can be reconfigured to shorten the work trestle so that the distance between the two leg attachment interfaces in the transport configuration of the work trestle is smaller than in the working configuration and that the working apparatus has a transport container with an internal compartment that allows the work trestle to be transported when it is in its shortened transport configuration compared the working configuration, wherein the transport container has at least one carrying handle that can be held for manual transport of the work trestle.

The working apparatus according to the invention allows for space-saving and very convenient transport of the associated work trestle. The handling involved in transporting the work trestle is comparable with that involved in using any transport container for other transport purposes, which makes handling the work trestle very simple. For transport, the work trestle can be shortened from its working length by simple reconfiguration, allowing the transport container used for transporting the work trestle to be adapted in terms of its dimensions to a container size that is commonly used for storing and transporting power tools or other tools, for example. This allows, where necessary, for space-saving integration into a system of stackable and uniformly transportable containers. For manual transport of the work trestle, the at least one carrying handle of the transport container belonging to the working apparatus can be used. In the transport configuration of the work trestle, not only is the length of the work trestle shortened, but the transverse dimensions of the work trestle are also reduced due to the support leg structures being moved closer to the support body, so that in the transport configuration of the work trestle, the working apparatus has extremely compact dimensions which not only facilitate manual transport but also appropriate storage along with other transport containers in a service vehicle. In order to implement the working apparatus, a work trestle can be combined with a separate transport container, for example, so that the intended use of the work trestle takes place without the transport container and combining it with the transport container into a transport unit is only necessary for actual transport purposes. However, in another configuration, the transport container can also directly function as the support body of the work trestle, making it an integral part of the work trestle both during its intended use and also during transportation.

Advantageous developments of the invention are derived from the dependent claims.

In order to keep the dimensions of the transport container as small as possible while still achieving a comfortable height for the object support surface relative to the ground when the work trestle is used in its working configuration, it is preferable for the height of the support leg structures measured vertically in the working configuration to be made greater than the height of the transport container when it is properly placed on the ground.

It is advantageous for the support body of the work trestle, regardless of whether it simultaneously functions as a transport container or not, to have a multi-part structure, specifically with two support body elements, each having one of the two leg attachment interfaces, which are movable relative to one another to vary the distance between the two leg attachment interfaces. The two support body elements may, for example, be displaceable relative to one another in the longitudinal trestle direction, wherein a telescoping feature can be provided. In another embodiment, the two support body elements can be pivotable relative to one another, allowing the support body to be folded together for reconfiguration for the purpose of length reduction.

Preferably, each support leg structure is pivotably mounted at its corresponding leg attachment interface in relation to the support body. In this way, the support leg structures can be folded away from the support body in their usage position when the work trestle is in its working configuration, and folded towards the support body in their non-usage position when the work trestle is in its transport configuration. Each leg attachment interface is particularly designed as a pivot bearing arrangement. Since the support leg structures preferably have a permanent connection to the support body in this case, accidental loss, for example on a cluttered construction site, can be avoided. Moreover, handling for the reconfiguration of the work trestle is very quick and easy to carry out.

The two support leg structures can, for example, each be designed as a uniformly manageable structure. For example, each support leg structure contains a single support leg with a relatively large base to obtain high stability, for example as a T-shaped design with the T-crosspiece acting as a resting section that can be placed on the ground. In another preferred embodiment, each of the two support leg structures has two individual support legs which, due to appropriately designed leg attachment structures, are pivotable relative to the support body between the non-usage and the usage positions and are also pivotable relative to one another for folding together and spreading apart in a direction orthogonal to the longitudinal trestle direction. Each support leg structure preferably contains a stabilization device in this case for releasably securing the spread-apart position, for example a foldable stiffening strut or a securing mechanism.

Instead of being attached by a pivot bearing, the support leg structures can also be fixed to the support body using a plug-in connection, wherein the leg attachment interface concerned is designed as a plug-in interface. When the work trestle is in its working configuration, each support leg structure is attached to the support body via the corresponding leg attachment interface in its usage position and when the work trestle is in its transport configuration, it is detached from the support body to assume its non-usage position. In the transport configuration, the detached support leg structures are moved closer to the support body by being placed next to or in the support body after removal, for example by placing them inside the transport container of the work trestle.

Preferably, each of the two support leg structures is designed to have a telescopically adjustable length, wherein it adopts an extended state in the usage position and a retracted state in the non-usage position with a shorter length compared with the usage position. In this way, the support leg structures can be shortened for a particularly space-saving transport configuration of the work trestle, namely regardless of the height level that the object support surface assumes when the support leg structures are extended in their usage position.

Irrespective of whether the transport container is designed separately from the work trestle or forms the support body of the work trestle, it is advantageous for the transport container to have two container elements that are opposite one another in the container height direction and are pivotable relative to one another, in order to specify either a closed state which closes the internal container space or an open state of the transport container which makes the internal container space accessible. Depending on the configuration of the work trestle, the container height direction can be oriented either in a vertical trestle height direction or in a horizontal trestle transverse direction when using the transport container as a support body. At least one carrying handle is arranged on the outside of one of the two container elements, allowing the transport container to be grasped for manual transport of the work trestle. Preferably, a carrying handle designed as a bracket handle is located on the outside of the other container element, opposite the one container element.

It has proved particularly advantageous for combined use with transport containers intended for other transport tasks if the transport container of the working apparatus has a rectangular outline, with particularly unequal side lengths, preferably in a format of about 40 cm by 30 cm.

Preferably, the transport container that can be used to transport the work trestle is equipped with a coupling system designed to stack the transport container and at least one additional storage container with a similar coupling system on top of one another and to detachably connect them to one another, in such a way that they form a unified, transportable stack of containers that cannot be separated from one another during transport. This provides the advantageous possibility of transporting and storing the work trestle together with storage containers that contain tools typically used on construction sites, for example, in a space-saving and secure manner. Different storage containers of this kind may, for example, be equipped with power tools such as cordless screwdrivers, saws or sanders.

The coupling system of the transport container preferably has an upper coupling device in the region of a upper side of the container and a lower coupling device in the region of a bottom side of the container. These two coupling devices are designed to fit together so that containers stacked on top of one another can be connected to one another in a detachable manner by coupling the upper and lower coupling devices facing one another in such a way that they cannot be lifted apart. In the coupled state, this creates a tension-resistant assembly in the stacking direction which can be separated by disconnecting the associated coupling devices. By lifting the uppermost container, whether it is the transport container of the work trestle or another storage container, the entire stacked container assembly can be lifted and transported.

In a simple embodiment, the working apparatus only contains the work trestle with an integrated or additional transport container. In a development, the working apparatus also contains one or multiple storage containers that have an identical coupling system to the transport container and can be detachably connected to the transport container of the work trestle.

As already mentioned earlier, the work trestle may be a component of the working apparatus separate from the transport container, wherein said work trestle is separated from the transport container in the working configuration and can be individually used for its intended purpose independently of the transport container. For its transport, the work trestle in this case is combined with the transport container when the transport configuration is adopted to form a transport unit which can be transported by gripping the at least one carrying handle of the transport container. One advantage of this design is that commercially available transport containers can be used to realize the working apparatus without any, or with only minor, modifications.

A particularly simple implementation of the basic idea of a transport container separate from the work trestle is to use the interior of the transport container to accommodate the work trestle in its transport configuration, thereby creating the transport unit. The work trestle adopting the transport configuration can then be placed into the interior of the transport container with a simple hand movement to form the transport unit.

In this context, it is advantageous for the transport container to have two container elements that are pivotably connected to one another, as mentioned earlier, with one forming a container base and the other a container lid arranged on the container base. To determine whether the transport container is in a closed or open state, the container lid can be positioned either in a closed position, where it seals and can be locked to secure the internal container space, or in an open position, where it provides access to the internal container space. The at least one and preferably only carrying handle is conveniently arranged on the outside of the container lid, particularly on an upper side of the container lid facing away from the container base.

In the case of a transport container separate from the work trestle, it is advantageous for the transport container to have a holding structure on the outside, to which the work trestle in its transport configuration can be detachably attached or attached to form the aforementioned transport unit. This opens up the possibility of using the interior of the transport container, which is equipped on the outside with the work trestle in its reduced transport configuration, for other storage purposes, for example, to accommodate a power tool or another processing machine.

One and the same transport container can be designed to form the transport unit in such a way that it can be used alternatively either to place a work trestle inside the internal container space or attach it to the outside of the container. In this way, it is also possible to transport two work trestles in a transport configuration at the same time by arranging one in the internal container space and the other on the outside of the container housing.

The holding structure for a work trestle that can be mounted on the outside of the transport container is preferably arranged on an outer surface of the transport container oriented orthogonally to a container height direction, wherein the transport container has the at least one carrying handle, in particular on an upper side oriented in the container height direction. The dimensions of the work trestle in the transport configuration are preferably reduced in such a manner that the work trestle mounted on the transport container remains entirely within the outline of the outer surface of the container provided with the holding structure.

As has also been mentioned above, in a preferred embodiment of the working apparatus, the transport container forms an immediately integral part of the work trestle, wherein the transport container forms the support body of the work trestle. Therefore, the transport container and support body represent one and the same component of the work trestle. Consequently, the need for a separate transport container is eliminated. In this way, the working apparatus can be realized with a particularly small number of components. Moreover, the transport container cannot be misplaced while the work trestle is in use.

One possible development of this working apparatus provides that the support leg structures, when the work trestle is in the transport configuration, are arranged on the outside of the support body which simultaneously acts as the transport container. The support leg structures are, for example, folded against the support body or fixed to the outside of the support body in some other way after being detached beforehand. The interior space of the transport container or support body can then be used for other storage purposes. However, a preferred development of the working apparatus provides that, when the work trestle is in the transport configuration, the interior space of the transport container which forms the support body defines a storage space for accommodating the two support leg structures in their non-usage position, so that the support leg structures are housed inside the support body during transportation of the work trestle. This results in a particularly space-saving arrangement in which the support leg structures do not protrude disruptively beyond the outer contour of the transport container.

It is advantageous for the storage space for the work trestle to have a rectangular outline. The entire interior space of the container is preferably used as a storage space for the work trestle. Optimal space utilization is possible if the support leg structures, in their non-usage position, are placed in the storage space with a diagonal orientation in respect of the rectangular outline. If the support leg structures are designed as multi-part structures to allow for a length variation, particularly as telescoping support leg structures, the available diagonal length of the storage space can make it possible to accommodate an only two-part support leg structure, where both leg parts are long enough to define a support leg length in the usage position that ensures a sufficient working height for the support surface of the support body.

The transport container, which also acts as the support body, preferably has two container elements that are pivotably fixed to one another, each forming one of the two support body elements of the support body. In the working configuration of the work trestle, the two support body elements adopt an unfolded position, arranged consecutively in the longitudinal trestle direction, and in the transport configuration of the work trestle, a folded position arranged side-by-side orthogonally to the longitudinal trestle direction. Each support body element has one of the two leg attachment interfaces. The pivot angle for the configuration change is preferably 180 degrees. The two support body elements are preferably of equal length to one another in the longitudinal direction of the work trestle. When the support body is unfolded, it effectively doubles in length.

In the working configuration of the work trestle, the two leg attachment interfaces are spaced apart from one another in the longitudinal trestle direction. This can also be the case in the transport configuration, but with a smaller distance compared with the working configuration.

In the transport configuration of the work trestle, the leg attachment interfaces are preferably arranged side-by-side, transverse to the longitudinal direction, which means the depending on the orientation of the pivot axis, the leg attachment interfaces are positioned side-by-side in the cross-direction or the height direction of the trestle. In the folded configuration of the support body, the leg attachment interfaces are preferably at the same height with respect to the longitudinal trestle direction.

Each of the two support body elements preferably has two opposing axial end faces oriented in the longitudinal trestle direction which are in particular at least substantially rectangular in outline. When the support body elements are positioned one behind the other, one of the end faces of the one support body element faces an end face of the other support body element, wherein said end faces, in particular, are in contact with one another, so that the two support body elements support one another and the unfolded support body provides a high degree of stability. In the region of the two end faces, which face one another when positioned one behind the other, the two support body elements are advantageously fixed to one another pivotably by a hinge device, wherein the hinge device defines a pivot axis orthogonal to the longitudinal trestle direction.

The support body is particularly of such dimensions that it has outer sides of unequal length, wherein the longest length is in one direction. When the support body elements are folded together, the support body is preferably at least substantially cuboid in shape, wherein one of the three edge lengths of the cuboid is greater than the other two edge lengths and defines the aforementioned longest length of the support body. The support body is preferably arranged so that, viewed in the side-by-side position, the longest length of the support body extends in the longitudinal trestle direction, so that when the support body elements are unfolded, this results in an increase in the length of the support body in the longitudinal direction of its greatest extent. This results, in particular, in a doubling of the greatest length.

A pivot axis defined by a hinge device, in particular, around which the two support body elements can be pivoted relative to one another for the purpose of changing position, preferably extends in a horizontal direction orthogonal to the longitudinal trestle direction or in a vertical height direction of the trestle orthogonal to the longitudinal trestle direction. With a support body that has the greatest length according to the above explanations it is advantageous for the pivot axis to run orthogonal to the longitudinal direction of the greatest length.

When considering the work trestle set up and ready for operation in its working configuration, the two support body elements can in particular be pivotably mounted to one another either with a horizontally or vertically oriented pivot axis. In this way, it is possible to influence, in particular, which of the outer sides of the support body elements defines the object support surface in the consecutive position.

Each of the two support body elements advantageously has an object support surface section on its upper side oriented in a direction orthogonal to both the longitudinal direction and the transverse direction of the trestle. In the ready-to-use configuration of the work trestle, each object support surface section faces vertically upwards. In the unfolded, consecutive position of the two support body elements, these object support surface sections complement one another to form a strip-like object support surface extending in the longitudinal trestle direction. The object support surface sections of the two support body elements may, for instance, be arranged on the outer sides of the two support body elements which are adjacent to one another and point in the same direction in the side-by-side position or face away from one another in the side-by-side position of the two support body elements. In this way, it is possible to influence, for example, whether the strip-like object support surface has a narrow or a relatively wide form.

Each object support surface section can be formed on a replaceable support plate of the associated support element. This allows for replacement in the event of damage. It is also possible for the optional installation of support plates with differently structured object support surface sections.

Each object support surface section may have fastening structures for attaching external objects, for example to enable a workpiece to be secured for processing by means of clamping devices.

It is advantageous for the support body to have at least one securing device that allows for a detachable, non-pivotable fixing of the two support body elements in both the side-by-side and consecutive positions. The securing device may have a separate securing unit for fixing each of the two positions. Each securing unit may be designed as a tension latch, for example.

Each of the two support body elements preferably has an open receiving recess on the side facing the other support body element in the side-by-side position which together define the internal container space when the support body elements are in the side-by-side position. To create the receiving recess, the respective support body element preferably has a shell-shaped design.

The internal container space space defined by the two receiving recesses can form the complete storage space for the support leg structures. However, for optimal utilization of the internal container space, it is advantageous if the receiving recess of each support body element is divided into multiple storage compartments by at least one partition wall, so that the internal container space formed in the side-by-side position of the support body elements has multiple internal compartments, one of which forms the storage space for receiving the support leg structures in their non-usage position and at least one additional internal compartment is provided for storing auxiliary objects, such as tools, for example.

One of the two support body elements advantageously has the at least one carrying handle on its outer side facing away from the other support body element in the side-by-side arrangement. The other of the two support body elements is advantageously provided with a base foot structure on its outer side facing away from the other support body element in the side-by-side arrangement, which can be used to rest the transport unit on a base.

The invention is explained in greater detail below with reference to the accompanying drawing. In the drawing:

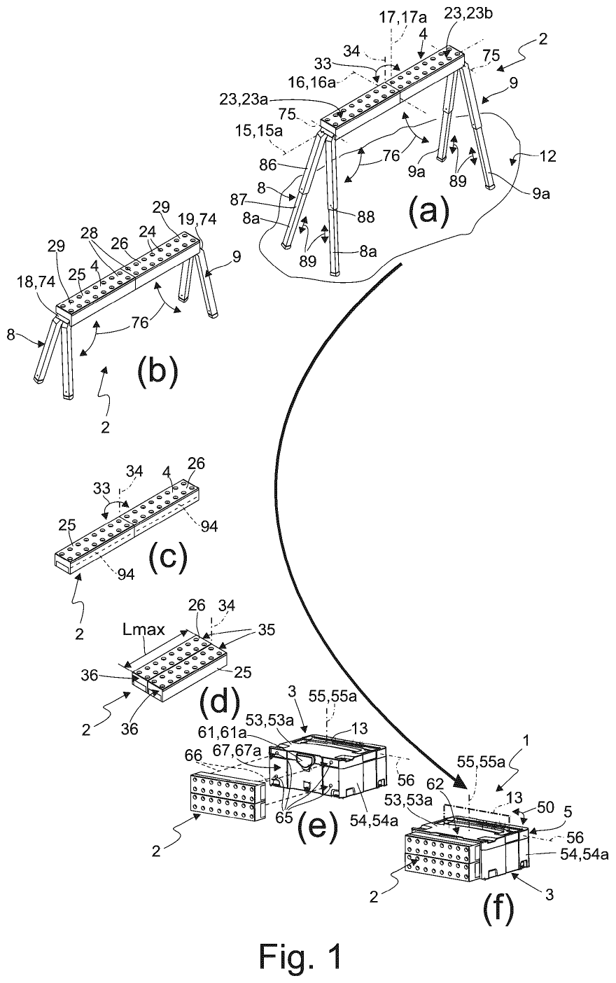

FIG. 1 shows a preferred first embodiment of the working apparatus according to the invention with a transport container separate from the work trestle, wherein the formation of a functional unit consisting of a work trestle and a transport container is illustrated in a handling sequence illustrated by illustrations (a) to (f),

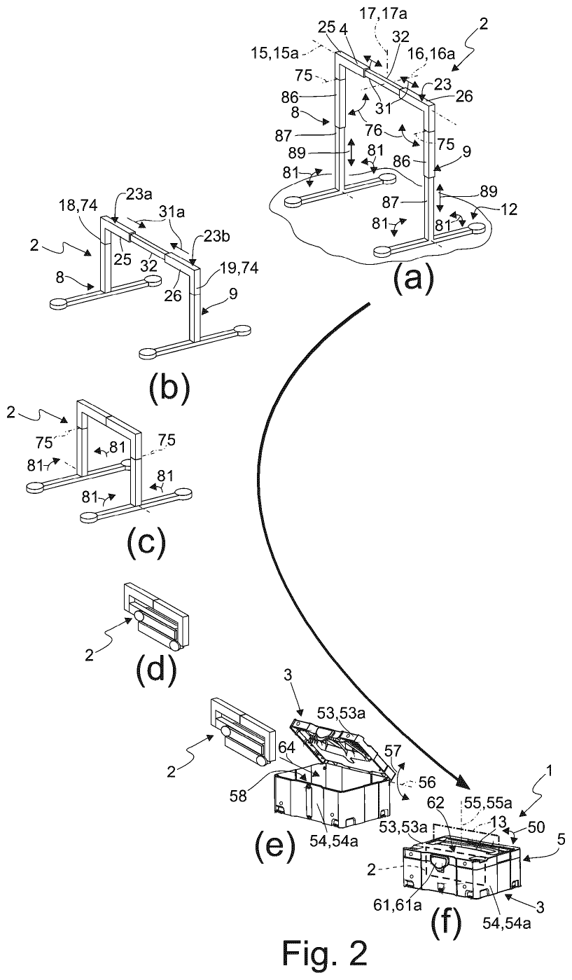

FIG. 2 shows, in a representation corresponding to FIG. 1, another working apparatus comprising a work trestle and a transport container separate therefrom,

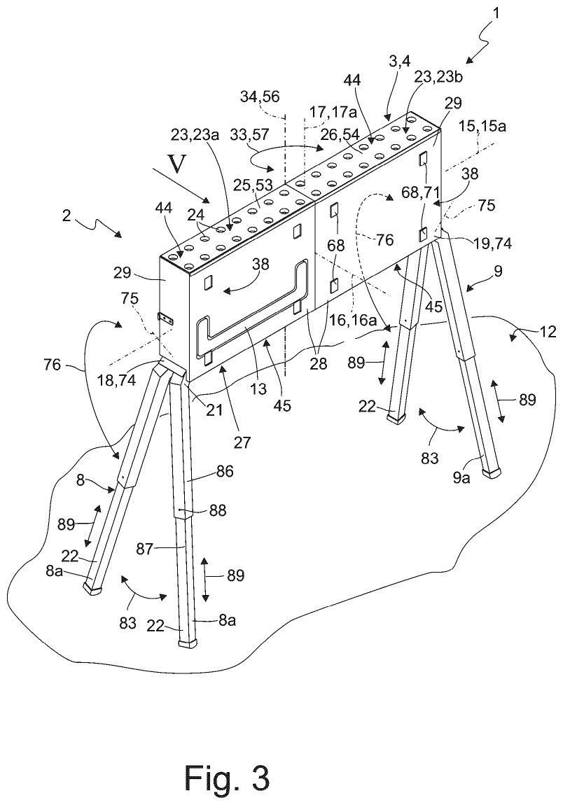

FIG. 3 shows a further preferred embodiment of the working apparatus according to the invention with a transport container integrated into a work trestle to form a support body, wherein the work trestle is shown in a ready-to-use configuration in which it is set up in a working configuration on a ground surface, for example, formed by a building floor,

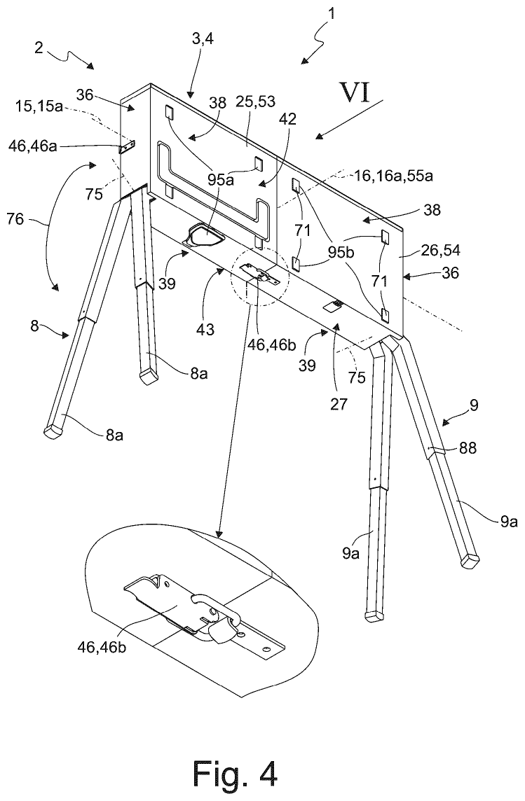

FIG. 4 shows the work trestle from FIG. 3 in turn in the working configuration, in a perspective bottom view, wherein a dash-dotted outlined area of a securing device is also shown separately in an enlarged detail,

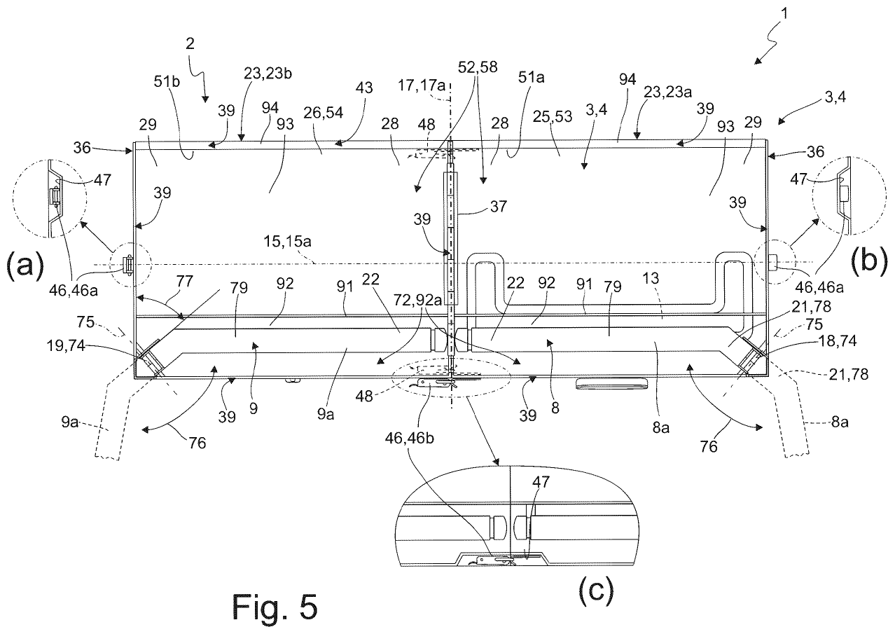

FIG. 5 shows the work trestle in FIGS. 3 and 4 in a side view with the viewing direction according to arrow V from FIG. 3, in an intermediate configuration in which the support leg structures are shown in a non-usage position folded towards the still unfolded support compared with the usage position visible in FIGS. 3 and 4. Additionally, some areas of the support body or transport container relating to a securing device of the support body or transport container are shown in separate enlarged detail views (a), (b) and (c) in alternative modified designs,

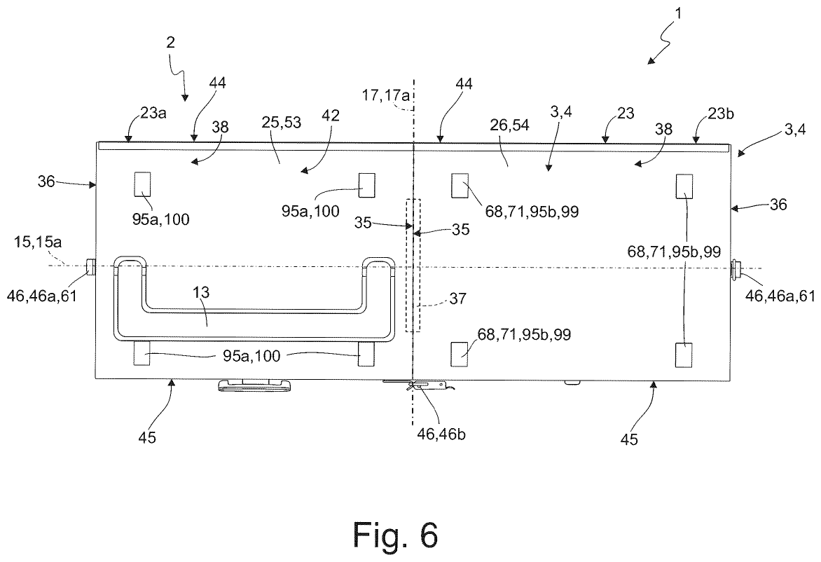

FIG. 6 shows the arrangement from FIG. 5 in the opposite viewing direction, corresponding to arrow VI from FIG. 4,

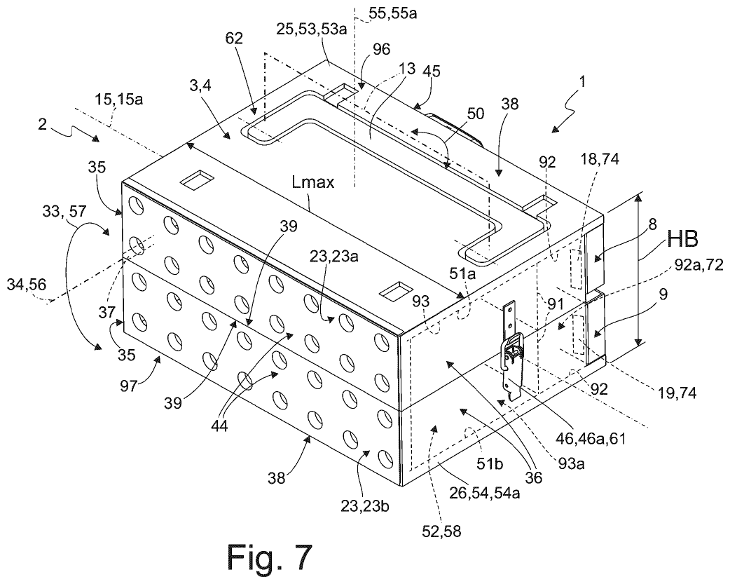

FIG. 7 shows the working apparatus from FIGS. 3 to 6 with the work trestle in a transport-ready transport configuration,

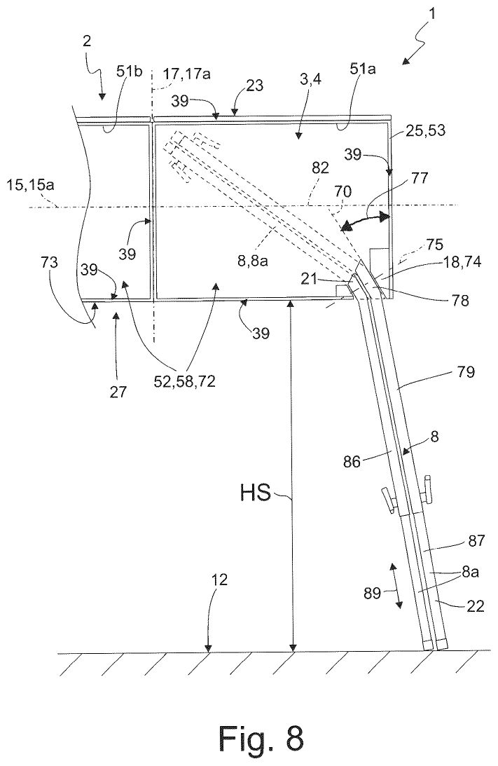

FIG. 8 shows an end section of a modified embodiment of a working apparatus compared with the design in FIGS. 3 to 7 with the work trestle in the ready-to-use configuration, wherein an advantageous option for designing and mounting a support leg structure is shown with the non-usage position also shown in dotted lines in addition to the usage position,

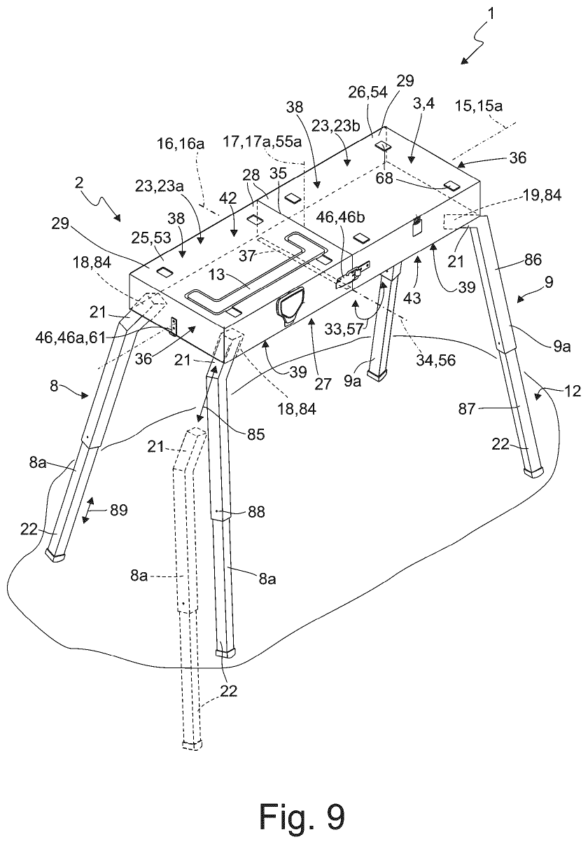

FIG. 9 shows a modified embodiment of the working apparatus compared with the embodiment in FIGS. 3 to 8 with a work trestle shown in a ready-to-use configuration similar to FIG. 3, in which the support body formed by the transport container has a rotation oriented by 90 degrees compared with the design in FIGS. 3 to 8 and in which, moreover, the support leg structures are preferably non-pivotable and instead are detachably fixed via plug-in interfaces on the support body, wherein a support leg of one of the support leg structures is also shown in a state removed from the support body indicated by a dash-dotted line,

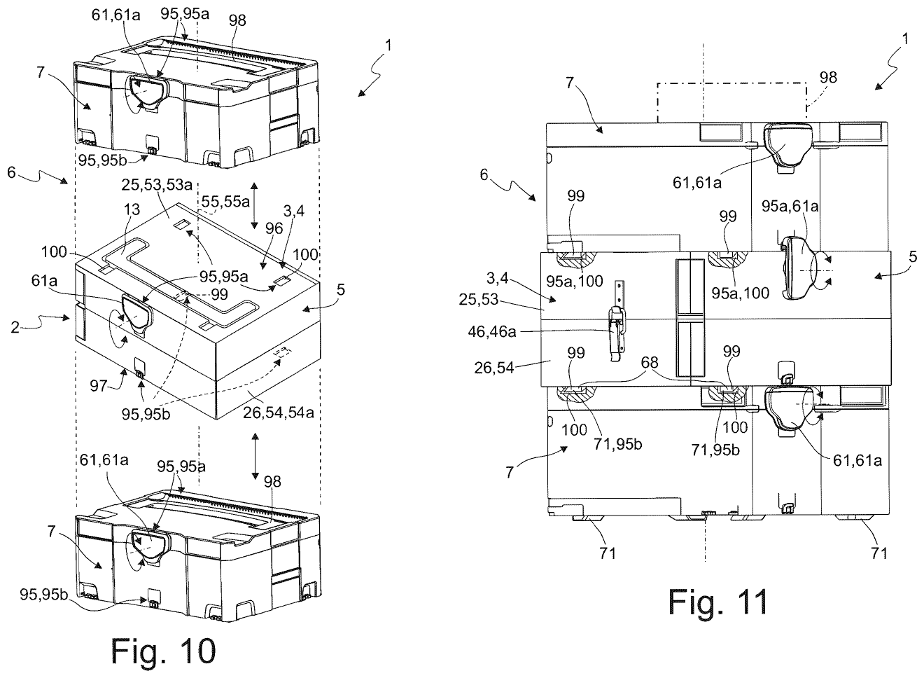

FIG. 10 shows an exploded view of a container stack assembly containing the transport container of a working apparatus, wherein the transport container is shown in a vertically arranged position between two storage containers used for different purposes and

FIG. 11 shows the container stack assembly from FIG. 10 with the individual containers in a stacked state, wherein some details of a coupling system intended for container coupling are visible in cut-out sections.

Unless otherwise specified in individual cases, the following descriptions relate to all exemplary embodiments of the working apparatus according to the invention referred to as a whole by reference sign 1.

The working apparatus 1 contains a transportable work trestle 2 and a transport container 3 that can be used when transporting the work trestle 2. The work trestle 2 has a support body 4, on which an object to be worked on (not further illustrated in the drawing) can be placed when the work trestle 2 is being used as intended.

In the working apparatus 1 in FIGS. 1 and 2, the work trestle 2 and the transport container 3 are designed as components of the working apparatus 1 that are separate from one another and are only combined into a transport unit 5, as shown in illustration (f) of FIGS. 1 and 2, to transport the work trestle 2. In the exemplary embodiments in FIGS. 3 to 9, the transport container 3 is a direct integral part of the work trestle 2, wherein it forms the support body 4, so that the transport container 3 and the support body 4 are one and the same object. When the transport container 3 is mentioned below, in the case of a work trestle 2 equipped with an integrated transport container 3 as shown in FIGS. 3 to 9, the support body 4 is also meant.

In the exemplary embodiment in FIGS. 10 and 11, the transport container 3, which can be coupled with one or multiple additional containers referred to as storage containers 7 to form a container assembly 6, can be either a transport container separate from the work trestle 2 or a transport container 3 integrated into the work trestle 2 acting as the support body 4.

The work trestle 2 can be manually converted between two configuration states that are particularly relevant for handling. These are a working configuration depicted in illustration (a) in FIGS. 1 and 2, as well as in FIGS. 3, 4, 8 and 9 and a transport configuration depicted in illustration (f) in FIGS. 1 and 2, as well as in FIGS. 7, 10 and 11. The working configuration is intended for the proper use of the work trestle 2, in which the work trestle 2, in a ready-to-use arrangement, is set up on any, particularly horizontal, ground surface 12 with two associated support leg structures 8, 9 which are also referred to as the first and second support leg structures 8, 9. This is illustrated in illustrations (a) in Figures 1 and 2 and in FIGS. 3, 8 and 9. The ground surface 12 may belong to a building floor or to any open area outside buildings, for example.

The transport configuration is provided for easy and compact transportation of the work trestle 2, wherein the transportation can be carried out by hand, in other words manually, with the help of the aforementioned transport container 3, specifically by using a carrying handle 13 that can be grasped with one hand, which is particularly an integral part of the transport container 3.

The transport container 3 can have multiple carrying handles 13 that can be used alternatively or cumulatively for transport purposes, wherein the present description refers to an embodiment with a single carrying handle 13, without this being intended as a limitation.

In its ready-to-use configuration, the work trestle 2, which assumes the working configuration, has a longitudinal trestle axis 15a extending in a longitudinal trestle direction 15, a transverse trestle direction 16 that is orthogonal to the longitudinal trestle direction 15 and formed by the axis direction of a transverse trestle axis 16a and a trestle height direction 17 that is orthogonal to both the longitudinal trestle direction 15 and the transverse direction 16 of the trestle, corresponding to the axis direction of a trestle height axis 17a. In the ready-to-use configuration, the longitudinal trestle direction 15 and the transverse direction 16 of the trestle are generally at least substantially horizontal, while the height direction 17 of the trestle is oriented vertically. The following descriptions refer to an orientation of this kind of the work trestle 2 which assumes the working configuration or the ready-to-use configuration, unless otherwise specified in individual cases.

The support body 4 extends in the longitudinal trestle direction 15. It preferably has a longitudinal extent with the greatest length extending in the longitudinal trestle direction 15. The support body 4 may be designed, for example, in a beam-like shape as shown in Figures 1 and 2 or in a plate-like shape as shown in FIGS. 3 and 9.

In two regions spaced apart from one another in the longitudinal trestle direction 15, one of two leg attachment interfaces 18, 19 is formed on the support body 4 in each case, said interfaces also being referred to below as the first and second leg attachment interfaces 18, 19. The first support leg structure 8 is mounted at the first leg attachment interface 18 and the second support leg structure 9 is mounted at the second leg attachment interface 19 in a positionally variable manner in each case. Positionally variable means that the leg attachment interfaces 18, 19 allow the relative position between the support leg structures 8, 9 and the support body 4 to be changed.

In the working configuration of the work trestle 2, the two support leg structures 8, 9 each take up a usage position projecting from the support body 4 transversely to the longitudinal trestle direction 15. In the ready-to-use arrangement, the support leg structures 8, 9 extend downwards starting from the support body 4. Each support leg structure 8, 9 has an upper end section referred to below as a coupling section 21, which is associated with the leg attachment interface 18, 19, and an opposite lower end section that forms a resting section 22, with which the support leg structure 8, 9 can be placed on the ground surface 12.

By changing the position of the support leg structures 8, 9 as already mentioned, the transport configuration of the work trestle 2 can be established. The support leg structures 8, 9 each take up a non-usage position in this case moved towards the support body 4, as can be seen, for example, in FIG. 1(c), FIG. 2(d), FIG. 5, FIG. 7 and, in dotted lines, FIG. 8.

The support leg structures 8, 9 each advantageously have a length extent between the coupling section 21 and the resting section 22, wherein in the transport configuration they extend in the longitudinal trestle direction 15, either substantially parallel thereto or at an inclination angle that is smaller than in the usage position and is, in particular, an acute angle.

The support body 4 has an object support surface 23 which, in the ready-to-use configuration, points upwards in the height direction 17 of the trestle and extends in the longitudinal trestle direction 15. The object support surface 23 has a strip-like shape, wherein it is narrower in the transverse direction 16 of the trestle than in the longitudinal trestle direction 15. The object support surface 23 is suitable for placing an object to be processed, for example a workpiece.

The object support surface 23 can be provided with attachment structures 24 to detachably secure a workpiece or other object to be processed and/or a processing machine. According to FIGS. 3 to 7, the attachment structure 24 may be a hole structure consisting of a plurality of attachment holes, in which clamping elements can be detachably fixed.

In the transport configuration, the work trestle 2 has a shorter length compared with the working configuration in the longitudinal trestle direction 15. This shorter length is particularly attributable to a shortening of the support body 4, which is designed to be reconfigured accordingly in terms of length. The variation in length of the support body 4 is associated with a change in distance between the two leg attachment interfaces 18, 19 arranged on the support body 4. The distance between them is shorter in the transport configuration of the work trestle 2 than in the working configuration.

In the working configuration of the work trestle 2, the two leg attachment interfaces 18, 19 are advantageously arranged at a maximum distance from one another in the longitudinal trestle direction 15. By comparison, the distance between the two leg attachment interfaces 18, 19 is smaller in the transport configuration, which also includes the possibility that there is no more space between the two leg attachment interfaces 18, 19 in the longitudinal trestle direction 15, because the two leg attachment interfaces 18, 19 are arranged side-by-side transversely to the longitudinal direction 15 and lie accordingly at the same height in the longitudinal trestle direction 15. This is exemplified by the exemplary embodiments in FIGS. 1 and 3 to 9, whereas in the exemplary embodiment in FIG. 2, there also remains a certain distance lengthwise in the longitudinal trestle direction 15 between the two leg attachment interfaces 18, 19 in the transport configuration.

The length adjustment of the support body 4 is particularly easy to perform if the support body 4 is designed in multiple parts according to the illustrated exemplary embodiments. It has two support body elements 25, 26 for this purpose which are referred to below, to distinguish them more easily, as the first support body element 25 and the second support body element 26. At least in the working configuration, the two support body elements 25, 26 are arranged consecutively in the longitudinal trestle direction 15.

Each support body element 25, 26 has one of two object support surface sections 23a, 23b that combine to form the object support surface 23 in the exemplary embodiments in FIGS. 1 and 3 to 9. According to the exemplary embodiment in FIG. 2, an extension element 32 that also has an additional object support surface section may be present to form the object support surface 23.

One of the two leg attachment interfaces 18, 19 is arranged on each of the two support body elements 25, 26. The leg attachment interfaces 18, 19 are advantageously located on an underside 27 of the support body 4 opposite the object support surface 23 in the height direction 17 of the trestle. Each support body element 25, 26 has a front end section 28 facing the other support body element 26, 25 in the working configuration and a rear end section 29 lying opposite in this respect. The leg attachment interfaces 18, 19 are advantageously located in the region of the rear end sections 29.

To adjust the length of the support body 4, the two support body elements 25, 26 may be displaceable relative to one another in the longitudinal trestle direction 15, which applies to the exemplary embodiment in FIG. 2, as indicated there by double arrows 31. For example, the two support body elements 25, 26 can engage telescopically and be slid into one another. An extension element 32 inserted between the two support body elements 25, 26 may be optionally present, which also forms a surface section of the object support surface 23. In the working configuration, the two support body elements 25, 26 are extended while maintaining a coherent structure, while they are retracted in the transport configuration according to the arrows 31a shown in FIG. 2(b). FIG. 2(c) shows the relative position of the two retracted support body elements 25, 26 in the transport configuration.

In the other illustrated exemplary embodiments, the two support body elements 25, 26 can be pivoted relative to one another for a configuration change in the context of a pivoting motion 33, indicated by a double arrow, around a pivot axis 34, allowing the configuration of the structure to change. In the working configuration, the two support body elements 25, 26 are arranged consecutively in the longitudinal trestle direction 15, which is referred to as the consecutive position for better differentiation. In the transport configuration, the two support body elements 25, 26 lie side-by-side, as shown in FIGS. 1(d) and 7, and this can be referred to as the side-by-side position. According to FIG. 1(d), the two support body elements 25, 26 are arranged horizontally side-by-side, while in FIG. 7 they are arranged vertically side-by-side, in other words on top of one another. It can be said that the two support body elements 25, 26 can be folded out into the consecutive position or folded in into the side-by-side position, depending on the direction of the pivoting movement 33. The pivot angle for the pivoting movement 33 is, by way of example, 180 degrees.

In the exemplary embodiments in FIGS. 1 and 3 to 9, each support body element 25, 26 has an axial end surface 35, 36 at its two axial end sections 28, 29, each oriented in the longitudinal trestle direction 15, with the front end section 28 referred to as the front end face 35 and the rear end section 29 referred to as the rear end face 36. In the consecutive position present during the working configuration, the front end faces 35 of the two support body elements 25, 26 face one another and, in particular, lie against one another. This is, in particular, a large-area contact. At the same time, the two rear end faces 36 in this case face in opposite directions to one another in the longitudinal trestle direction 15.

The pivot axis 34 is advantageously located in the transition region between the two front end faces 35 adjoining one another, in particular at an edge of the relevant front end face 35 in each case. To define the pivot axis 34, a hinge device 37 only indicated schematically is provided, which allows the two support body elements 25, 26 to be fixed to one another in the region of the front end faces 35 in a pivotable manner. The hinge device 37 contains, for example, two hinge elements each attached to one of the two support body elements 25, 26 with hinge eyes aligned with one another, through which a hinge bolt is inserted, the longitudinal axis of which defines the pivot axis 34.

The preferred position of the pivot axis 34 can best be explained using the folded-together side-by-side position of the two support body elements 25, 26, which is clearly visible in FIG. 7, for example. Due to the folded state of the two support body elements 25, 26, the two front end faces 35 and the two rear end faces 36 in this case point in the same direction in the longitudinal trestle direction 15. The two front end faces 35 are positioned at least substantially at the same height in the longitudinal trestle direction 15 in this case, wherein they advantageously lie in a common plane orthogonal to the longitudinal trestle axis 15a. The pivot axis 34 extends in the transition region between the two front end faces 35, as realized by a correspondingly placed hinge device 37.

Each support body element 25, 26 has two first and second outer element surfaces 38, 39 that are opposite and face away from one another. In the working configuration, the first two outer surfaces 38, 38, on the one hand, and the second two outer element surfaces 39, 39, on the other, are adjacent to one another and each lie, in particular, in a plane parallel to the longitudinal trestle direction 15. The first two outer element surfaces 38, 38 together define a first side surface 42 of the unfolded support body 4, while the second two outer element surfaces 39, 39 together define a second side surface 43 of the support body 4 opposite the first side surface 42 transversely to the longitudinal direction 15. In the folded side-by-side position, the support body elements 25, 26 lie against each other with their second outer surfaces 39, 39 facing one another, so that they can mutually support one another.

FIG. 7 illustrates that the two leg attachment interfaces 18, 19 indicated here only in dotted lines are preferably at the same height in the folded side-by-side position with respect to the longitudinal trestle direction 15.

The support body 4 is particularly designed so that, in the side-by-side position of the two support body elements 25, 26 as shown in FIGS. 1(d) and 7, for example, it has a maximum length “Lmax” extending in the longitudinal trestle direction 15. In every direction orthogonal to the longitudinal trestle direction 15, the dimensions of the support body 4 are smaller than the aforementioned maximum length “Lmax”. This configuration provides the advantage that unfolding the support body elements 25, 26 results in a length extension of the support body 4 in the longitudinal extent direction of the maximum length “Lmax”, wherein it specifically involves a doubling of the length, for example. In the unfolded side-by-side position of the support body elements 25, 26, the support body 4 therefore has a length equivalent to twice the maximum length “Lmax” of the folded support body 4. This results in the largest possible usable object support surface 23 in the working configuration, combined with a support body 4 that can be folded away very compactly for the transport configuration.

Each support body element 25, 26 also has, in addition to the front and rear end faces 35, 36 and the first and second outer element surfaces 38, 39, two third and fourth outer surfaces 44, 45 opposite one another which are each oriented perpendicular to the two end faces 35, 36 and the first and second outer element surfaces 38, 39. The first, second, third and fourth outer element surfaces 38, 39, 44, 45 have the same length in the longitudinal trestle direction 15 but differ in their width orthogonally to the longitudinal trestle direction 15. In particular, the first and second outer element surfaces 38, 39 have a greater width than the third and fourth outer element surfaces 44, 45.

Depending on how the orientation of the pivot axis 34 is chosen, it is possible to predetermine whether one of the first and second outer surfaces 38, 39 or one of the third and fourth outer surfaces 44, 45 forms the section of the object support surface 23a, 23b that contributes to the formation of the object support surface 23. In the exemplary embodiment in FIGS. 1 and 3 to 8, the pivot axis 34 is aligned in the vertical height direction 17 of the trestle, which results in the third outer element surfaces 44 pointing vertically upwards and, in the unfolded, consecutive position of the support body elements 25, 26, jointly defining a relatively narrow, strip-shaped object support surface 23.

In the exemplary embodiment in FIG. 9, the pivot axis 34, by contrast, runs in the transverse direction 16, wherein in the unfolded consecutive position of the support body elements 25, 26, their first outer element surfaces 38 point vertically upwards and jointly form the object support surface 23. In this case, the object support surface 23 also has a strip-like longitudinal shape, but with a greater width in the transverse direction 16 of the trestle compared with the exemplary embodiments in FIGS. 1 and 3 to 8.

While, therefore, in the exemplary embodiments in FIGS. 1 and 3 to 8 the object support surface sections 23a, 23b of the two support body elements 25, 26 are located on outer sides of this kind, namely on the two third outer surfaces 44, 44 which lie next to one another in the side-by-side position and face the same direction, in the embodiment in FIG. 9, the object support surface sections 23a, 23b are arranged in such a way that, in the side-by-side position of the two support body elements 25, 26 shown in FIG. 7, they are arranged on opposite outer sides, namely on the first two outer element surfaces 38, 38, facing away from one another.

In each support body element 25, 26, the object support surface section 23a, 23b is formed on a support plate 94 that can be replaced if necessary.

The support body 4 is advantageously equipped with at least one securing mechanism 46 which allows the two support body elements 25, 26 to be fixed in both the side-by-side and consecutive positions without the possibility of pivoting relative to one another.

The securing mechanism 46 preferably contains by way of example separate first and second securing units 46a, 46b for the side-by-side and consecutive positions, respectively, wherein by way of example, the first securing unit 46a is designed to secure the side-by-side position and the second securing unit 46b is designed to secure the consecutive position.

Each securing unit 46a, 46b preferably has two securing components that can be locked to one another in a detachable manner, with one arranged on the first support body element 25 and the other on the second support body element 26. For example, the securing units 46a, 46b are designed as tension latches according to the illustrated exemplary embodiment, with a tension hook as the first securing element and a movable tension clamp as the second securing element, wherein the tension clamp can be manually engaged and disengaged with the tension hook to activate or deactivate the respective securing unit 46a, 46b.

In the illustrated exemplary embodiments, the securing units 46a, 46b are mounted on the outer side of the respective support body element 25, 26. They may be attached directly, so that they project beyond the outer surface of the associated support body element 25, 26. However, as illustrated in the details in FIGS. 5(a), 5(b) and 5(c), the advantageous option exists to recess the securing units 46a, 46b into wall recesses 47 in the associated support body element 25, 26.

In addition, as indicated by the dashed representation 48 in FIG. 5, there is the option to arrange one or more of the securing units 46a, 46b on an inner surface of the support body elements 25, 26. This is particularly the case in connection with a preferred design also realized in the illustrated embodiments, in which the two support body elements 25, 26 each have a recess 51a, 51b, the open sides of which are associated with the second outer surfaces 39, so that in the side-by-side arrangement of the two support body elements 25, 26, they face each other and thereby jointly enclose an internal space 52 of the support body 4. In this context, it is advantageous if the two support body elements 25, 26 are each designed in a shell shape, as shown in the illustrated exemplary embodiments. The second outer element surfaces 39 in this case are limited to the edge surfaces of the wall sections of the respective support body element 25, 26 that frame the receiving recesses 51.

Alternatively, it is possible for the securing mechanism 46 for both the side-by-side and the consecutive positions to be formed integrally with the hinge mechanism 37. Advantageously, the hinge mechanism 37 is designed so that it can be locked in both the side-by-side and the consecutive positions.

As mentioned above, the work apparatus 1 has a transport container 3 equipped with a handle 13, with the help of which the work trestle 2 can be easily and space-efficiently transported by hand when it is in its transport configuration. In the exemplary embodiments shown in FIGS. 1 and 2, the transport container 3 is a device component separate from the work trestle 2, while in the exemplary embodiments shown in FIGS. 3 to 9, it is designed as a structural unit with the support body 4.

The transport container 3 has a first container element 53 and a second container element 54. In the exemplary embodiments shown in FIGS. 3 to 8, the first container element 53 represents the first support body element 25 and the second container element 54 represents the second support body element 26.

The transport container 3 has a vertical container axis 55a extending in the container height direction 55. The two container elements 53, 54 are positioned opposite one another in the container height direction 55 and are pivotable relative to one another around a pivot axis, referred to for better differentiation as the container pivot axis 56, to allow a pivoting movement 57 indicated by a double arrow, which is also referred to as the container element pivoting movement 57.

The two container elements 53, 54 jointly enclose an internal container space 58 which, as shown for example in FIG. 2(e) or FIG. 5, is accessible from the outside when in an open state and which, as shown for example in FIGS. 1(f), 2(f) and 7, is closed in an inaccessible manner from the outside when in a closed state.

The second container element 54 preferably forms a container base 54a, while the first container element 53 forms a container lid 53a. During the container element pivoting movement 57, the container lid 53a can be pivoted towards the container base 54a to close the internal container space 58, thereby defining the closed state. Furthermore, the container lid 53a can be pivoted upwards in respect of the container base 54a into an open position that makes the internal container space 58 accessible, thereby defining the open state of the transport container 3.

In the closed state, the transport container 3 can be grasped by the handle 13 for transport purposes. The handle 13 is advantageously positioned on the outside of the first container element 53, so that it can be easily gripped from above when the transport container 3 is positioned with a vertical container axis 55a.

The handle 13 is preferably a substantially U-shaped bow handle which is pivotally arranged on the first container element 53, as indicated by the double arrow 50, so that it can be folded down towards the first container element 53 when not in use and folded up in relation to the first container element 53 for use.

The transport container 3 is preferably equipped with a securing device 61 that allows the first container element 53 to be locked in the closed position in a non-pivotable but releasable manner with respect to the second container element 54. This ensures that the two container elements 53, 54 remain securely connected when the transport container 3 is picked up by the handle 13 which is arranged on a container upper side 62 oriented upwards in the container height direction 55.

In a preferred embodiment, the transport container 3 is designed in the same way as the support body 4 described earlier based on FIGS. 3 to 9. Therefore, the descriptions given there also apply directly to the transport container 3, wherein in the exemplary embodiments in FIGS. 3 to 9, the container pivot axis 56 corresponds to the pivot axis 34 and the container element pivoting movement 57 corresponds to the pivoting movement 33.

If the transport container 3 forms the support body 4, the securing device 61 can be formed by the securing device 46 and, in particular, by the first securing unit 46a, as is the case in the exemplary embodiments shown in FIGS. 3 to 9.

In the work apparatus 1 according to FIGS. 3 to 8, the transport container 3 acting as the support body 4 is positioned with the container vertical axis 55a in a horizontal orientation in the ready-to-use configuration of the work trestle. The handle 13 is located on one of the two outer element surfaces 38 in this case. For transporting the work trestle 2, the folded support body 4 or transport container 3 is advantageously used in a spatial orientation shown in FIG. 7, in which the container vertical axis 55a is oriented vertically.

The same container orientation is also achieved during transport of the folded work trestle in the exemplary embodiment shown in FIG. 9. In this case, however, the unfolded support body 4 or transport container 3 is oriented in such a manner that the container vertical axis 55a is oriented vertically.

In the exemplary embodiments shown in FIGS. 3 to 9, the internal container space 58 of the transport container 3 defines the internal support body space 52 formed by the two receiving recesses 51a, 51b.

Transversely to the container height direction 55, the transport container 3, and therefore also the support body 4, advantageously have an at least substantially rectangular outline. The outer dimensions of the outline are approximately 40 cm as the greatest length “Lmax” and 30 cm perpendicular thereto. Container dimensions of this kind allow for optimal use alongside other storage containers 7 which have similar outlines and are used, for example, for storing and transporting machines intended for use along with the work trestle 2. Storage containers 7 of this kind are illustrated, as previously mentioned, in FIGS. 10 and 11.

According to the exemplary embodiment in FIG. 2, the work trestle 2 in its transport configuration can be combined with the transport container 3 into a uniformly transportable unit 5 by placing it, as indicated by arrow 64, inside the internal container space 58 of the transport container 3. FIG. 2(d) shows the work trestle 2 in the transport configuration and FIG. 2(e) illustrates how the work trestle 2 configured in this manner is inserted according to the arrow 64 into the internal container space 58 which is accessible due to the first container element 53 being pivoted into an open position. FIG. 2(f) shows the finished transport unit 5 with the work trestle 2 only indicated by dotted lines inside the internal container space 58 of the closed transport container 3 locked by the locking device 61. The pivotable handle 13 is folded up into a usage position, as indicated by the dotted lines and double arrow 50, so that it can be grasped by a person with one hand to carry the transport container 3 containing the work trestle 2.

According to the exemplary embodiment in FIG. 1, the work trestle 2 in its transport configuration can be fixed to the outside of the transport container 3 in a detachable manner to form a transport unit 5. In this case, the transport container 3 has a holding structure 65 on its outer surface which is always accessible and said holding structure allows for the folded work trestle 2 to be fixed in a detachable manner.

The holding structure 65 contains, for example, a latch mechanism or a locking mechanism that matches complementary structures on the work trestle 2, allowing for simple and easily detachable fastening when needed. For example, the holding structure 65 may have one or multiple holding straps that can be used to hold the work trestle 2 in place in a detachable manner.

FIG. 1(d) shows the work trestle 2 in its transport configuration, said work trestle being attached according to FIG. 1(e) to the transport container 3 at the holding structure 65, as indicated by arrows 66. FIG. 1(f) shows the finished transport unit 5 with the handle 13 folded up for manual transportation, similar to FIG. 2(f).

Since the internal container space 58 is not required for transporting the work trestle 2 in the embodiment in FIG. 1, said internal container space 58 can used for other purposes simultaneously.

The holding structure 65 can be arranged anywhere on the outside of the transport container 3. It is preferably placed on an outer container surface 67 oriented orthogonally to the container height direction 55, particularly on the front container outer surface 67a opposite the position of the container pivot axis 56, where the locking device 61 is also advantageously located. The work trestle 2 and the transport container 3 are particularly coordinated in such a manner that the work trestle 2 attached to the holding structure 65 in the transport configuration only extends within the outline of the outer container surface 67 provided with the holding structure 65.

To allow the transport unit 5 to be stacked vertically with other storage containers 7 without any protruding parts, as shown in FIGS. 10 and 11, it is advantageous for the outline of the transport unit 5 in a plane orthogonal to the container height direction 55 to be at least substantially the same or smaller than that of the other storage containers 7. In the exemplary embodiments in FIGS. 2 and 3 to 9, a transport container 3 with the corresponding outline dimensions can be used without any issues. In the exemplary embodiment in FIG. 1, it is advisable for the transport container 3 with a smaller outline compared with the storage containers 7 to be used, wherein the saved space is used for attaching the work trestle 2. In this way, the outline of the transport unit 5, despite having the work trestle 2 mounted on the outside of the transport container 3, at least substantially matches the same floor area grid as the storage containers 7.

The transport container 3, or the support body 4 simultaneously representing the transport container 3, preferably has a support foot structure 68 on its outer side, with which the transport container 3 or the folded support body 4 can be placed on a surface, for example the ground surface 12, without tipping when not in use. On the support body 4, the support foot structure 68 is preferably located on the first outer element surface 38 of the second support body element 26. Consequently, the handle 13 and the support foot structure 68 are arranged on outer sides of the folded support body 4 that are opposite one another and face away from one another.

In the case of the exemplary embodiments having a separate transport container 3 in FIGS. 1 and 2, the optional support foot structure 68 is located on the underside of the second container element 54 facing away from the first container element 53 in the container height direction 55.

The support foot structure 68 is advantageously composed of multiple support feet 71 distributed across the assigned outer surface of the transport container 3 or the support body 4 and raised in the manner of protrusions relative to the aforementioned outer surface.

The work apparatus 1 is advantageously designed in such a manner that the height “HS” of the support leg structures 8, 9 measured vertically in the ready-to-use configuration, which corresponds to the distance between the ground surface 12 and the lower edge 73 of the support body 4 (FIG. 8) is greater than the height “HB” of the transport container 3 measured in the container height direction 55 (FIG. 7), namely including the optional support foot structure 68.

Due to the identity of the object between the transport container 3 and the support body 4 in an embodiment according to FIGS. 3 to 9, in the closed state of the transport container 3 or of the support body 4, the internal support body space 52 is formed by the internal container space 58. The internal support body space 52 in this case defines a storage space 72 in which the support leg structures 8, 9 in their non-usage position are housed while the work trestle 2 is being transported. For this purpose, the support leg structures 8, 9 are either folded up to the support body 4, while retaining their existing mechanical connection to the support body 4, in such a manner that they occupy a position within the storage space 72, according to a first variant, or the support leg structures 8, 9 are removed from the support body 4 after releasing the mechanical connection and placed as individual components inside the storage space 72, according to a second variant. The first variant is exemplified in the exemplary embodiments in FIGS. 3 to 8 and the second variant in the exemplary embodiment in FIG. 9.

In order to implement the aforementioned first variant, each support leg structure 8, 9 is pivotally mounted on its associated leg attachment interface 18, 19 on the support body 4. Each leg attachment interface 18, 19 is formed as a pivot bearing device 74 for this purpose, through which at least one pivot axis, referred to for clarity as the support leg pivot axis 75, is defined, about which the associated support leg structure 8, 9 can be pivoted relative to the support body 4 to switch between the usage and non-usage positions. The pivot motion that each support leg structure 8, 9 can perform in this case-referred to for clarity as the support leg pivot movement 76-is indicated in the drawing by double arrows. In FIG. 5, the non-usage position of the support leg structures 8, 9 folded to the support body 4 is shown with solid lines and the folded-away usage position is indicated with dotted lines.

The support leg pivot axis 75 is preferably oriented on the respective associated support body element 25, 26 in such a manner that it extends in a plane parallel to both the longitudinal trestle axis 15a and the trestle height axis 17a when the work trestle 2 is in its ready-to-use configuration. Therefore, the support leg pivot movement 76 takes place transversely to the longitudinal trestle direction 15. However, another orientation of the support leg pivot axis 75 is also possible in principle, so that the support leg pivot movement 76 takes place in a plane orthogonal to the transverse trestle axis 16a, as is the case in the exemplary embodiment in FIG. 1.

The pivot bearing device 74 can be implemented, for example, by forming a tab arrangement on the relevant support body element 25, 26, on which a bearing pin passing through the support leg structure 8, 9 is fixed, in relation to which the support leg structure 8, 9 is pivotable.

By appropriately selecting a pivot axis inclination angle 77 which is present in the ready-to-use configuration between the trestle height direction 17 and a reference plane 70 orthogonal to the support leg pivot axis 75, as indicated in FIGS. 5 and 8, the alignment of the support leg structures 8, 9 in the folded non-usage position relative to the associated support body element 25, 26 can be influenced, taking account of the shape of the support leg structures 8, 9.

In relation to the design of the support leg structures 8, 9, they may have a simply angled longitudinal shape, with a relatively short bearing section 78 associated with the pivot bearing device 74 and a main length section 79 extending between the bearing section 78 and the resting section 22.

In the exemplary embodiments in FIGS. 3 to 7, the configuration is such that in the non-usage position the support leg structures 8, 9 extend at least substantially, and particularly with their main length section 79, within the storage space 72 in a storage space longitudinal direction 82, indicated by a dotted line that runs parallel to the longitudinal direction 15 when the work trestle 2 is in its usage configuration.

A particularly effective use of space within the storage space 72 is achieved when the pivot axis inclination angle 77 and the design of the support leg structures 8, 9 are coordinated with one another according to the exemplary embodiment in FIG. 8, in such a manner that the support leg structure 8, 9 extends in the non-usage position within the storage space 72 in a diagonal alignment relative to a rectangular outline of the storage space 72. In FIG. 8, the non-usage position of the first support leg structure 8 is indicated by dotted lines.

The storage space 72 is formed by the internal support body space 52, either by the entire internal support body space 52 or by a part of it. Accordingly, it preferably consists of the two receiving recesses 51a, 51b, each formed in one of the support body elements 25, 26. Each of the two support leg structures 8, 9 is advantageously housed in one of the two receiving recesses 51a, 51b in the non-usage position.

In their usage position, the support leg structures 8, 9 project in the trestle height direction 17 beyond the downwardly-facing fourth outer element surface 45. When pivoted into the non-usage position, the support leg structures fit into the open receiving recesses 51a, 51b in the region of the second outer element surface 39.

Each support leg structure 8, 9 can, in principle, consist of just a single support leg, as shown in the exemplary embodiment in FIG. 2. In this case, it is only necessary to design the resting sections 22 so that they ensure sufficient stability. For example, the support legs may be T-shaped, wherein the T-crossbar defines the resting section 22. This applies not only to pivotable support leg structures 8, 9, but also to an embodiment of the work trestle 2 in which each support leg structure 8, 9 is attachable via a plug-in connection at its associated leg attachment interface 18, 19. However, it is considered advantageous for each support leg structure 8, 9 to have two individual support legs 8a, 8b, or 9a, 9b, respectively, which are arranged in pairs on one of the two support body elements 25, 26 by means of the leg attachment interface 18, 19 located there.

For pivotably designed support leg structures 8, 9, the two support legs 8a, 8b; 9a, 9b of each support leg structure 8, 9 are preferably pivotable about a common support leg pivot axis 75, so that they can be pivoted in a single pivoting movement between the non-usage and usage positions, despite their individual natures. The common support leg pivot axis 75 also allows, in particular, the two support legs 8a, 8b; 9a, 9b belonging to the same support leg structure 8, 9 to be pivoted relative to one another for folding together or spreading apart in the transverse direction 16 of the trestle, as indicated by double arrows 83 in the drawing.

The support legs 8a, 8b; 9a, 9b in this case may be arranged offset to one another particularly along the support leg pivot axis 75, as shown in FIG. 8, or arranged one behind the other in the transverse trestle direction 16, as indicated in FIG. 5.

For support leg structures 8, 9 that can be attached detachably, the leg attachment interfaces 18, 19 are designed as plug interfaces, as shown in the depiction in FIG. 9. For example, each leg attachment interface 18, 19 contains a plug-in receptacle 84, indicated by dotted lines, into which the corresponding leg 8a, 8b; 9a, 9b is inserted in the usage position. Securing means that are not further illustrated ensure a detachable, loss-proof fixing in the usage position. To reposition into the non-usage position, the support legs 8a, 8b; 9a, 9b can be simply pulled out of the associated plug-in receptacle 84 according to the double arrow 85 in FIG. 9 after manually deactivating the securing means beforehand, so that they are detached from the support body 4.

The support leg structures 8, 9 may each have a multi-part construction so that they have an integrated folding mechanism, allowing them to be folded and unfolded to adjust their dimensions. This is exemplified by the embodiment in FIG. 2. Various arrows 81 indicate the possible folding movements in FIG. 2.

To easily achieve particularly compact dimensions for the transport configuration of the work trestle 2, it is advantageous if, as in all the illustrated exemplary embodiments, the two support leg structures 8, 9 have telescopic length adjustment. To this end, each support leg structure 8, 9 has a multi-part design and can be optionally adjusted via a telescopic movement 89 indicated by means of a double arrow, to allow the usage position by being extended or to allow the non-usage position by being retracted into a shorter length compared with the usage position. The above explanations apply to each individual leg 8a, 8b; 9a, 9b when the support leg structures 8, 9 each consist of multiple individual support legs.

When converting the work trestle 2 from the transport configuration into the usage configuration, the support leg structures 8, 9 or the individual support legs 8a, 8b; 9a, 9b are preferably brought from the non-usage position into the usage position in the retracted state and only then extended to the desired leg length. During the reverse reconfiguration, the support leg structures 8, 9 are preferably moved into the retracted state before being moved from the non-usage position into the usage position. However, extending or retracting can also take place in principle before the change in position.

Regardless of whether a support leg structure 8, 9 corresponding to the exemplary embodiment in FIG. 2 consists of only a single support leg or, as in the other exemplary embodiments, has multiple support legs 8a, 8b; 9a, 9b, it is advantageous for each support leg 8a, 8b; 9a, 9b to consist of only two telescopic elements 86, 87 that are displaceable relative to one another by performing the telescoping movement 89, one of which is associated with the leg attachment interface 18, 19 and the other forms a resting section 22. In principle, however, each support leg 8a, 8b; 9a, 9b can also have more than two telescopic elements 86, 87. Telescopic elements 86, 87 that can be slid into one another can preferably each be locked in the extended relative position by manually operable locking means 88.

According to the illustration in FIG. 5, the receiving recess 51a, 51b of each support body element 25, 26 can be divided by at least one partition wall 91 into multiple storage compartments 92, 93 which, in the side-by-side position of the support body elements 25, 26, each form one of several internal compartments 92a, 93a in pairs. One of these internal compartments 92a represents the storage space 72 for the folded support leg structures 8, 9, while at least one other internal compartment 93a can be used to receive additional items such as tools, for example.

The above explanations regarding the fixing and design of the support leg structures 8, 9 apply correspondingly to the exemplary embodiments in FIGS. 1 and 2. In these FIGS. 1 and 2, it is clearly illustrated, following the direction of the curved arrow, how a work trestle 2 in the usage configuration can be converted into a transport configuration by appropriate handling of the support body 4 and the support leg structures 8, 9, in such a manner that can form a transport unit 5 together with a transport container 3.

As mentioned above, it is advantageous for the transport container 3 that can be used to transport the work trestle 2, regardless of whether it is formed separately from the work trestle 2 or constitutes the support body 4, to be equipped with a coupling system 95 that allows the transport container 3, as illustrated in FIGS. 10 and 11, to be coupled with one or more additional containers, referred to as storage containers 7, to form a uniform transportable container stack assembly 6.

The coupling system 95 advantageously has an upper coupling device 95a arranged in the region of the container upper side 96, oriented in the container height direction 55, and a lower coupling device 95b arranged at the container underside 97. Each storage container 7 is similarly equipped with upper and lower coupling devices 95a, 95b.

The upper and lower coupling devices 95a, 95b are adapted to one another in such a manner that, through their interaction, the containers 3, 7 stacked directly on top of one another can be detachably coupled to one another in a manner that prevents them from being lifted apart. A coupled state of this kind is shown in FIG. 11 in connection with the transport container 3 and an upper storage container 7 stacked thereon. Although the lower storage container 7 is also stacked, the coupling system 95 is still deactivated, however, allowing the transport container 3 to be removed.

When all containers 3, 7 are coupled to one another in a manner that prevents them from being lifted apart, the resulting container stack assembly 6 can then be transported as a unit by means of a handle 98 of the uppermost container, wherein the uppermost container can be either a storage container 7 or directly the transport container 3. In the latter case, the handle 98 is formed by the carrying handle 13.

The locking device 61 explained above preferably belongs at least in part to the coupling system 95.

For example, the coupling system 95 may include a rotary latch 61a, which can be rotated into a coupling position shown in FIG. 11 at the middle rotary latch 61a, where it couples the transport container 3 with the storage container 7 stacked thereon, in the region of a container front side, in a manner that prevents them from being lifted apart. The rotary latch 61a may be simultaneously part of the locking device 61.

Further components of the coupling system 95 are, for example, coupling projections 99 formed on the container underside 97 and coupling recesses 100 formed on the container upper side 96. In the stacked state of the transport container 3 and a storage container 7, the coupling projections 99 and coupling recesses 100 interlock at least partially with one another, in such a way that they overlap transversely to the container height direction 55 and create a mutual engagement that prevents the two containers 3, 7 from being lifted apart. The coupling projections 99 preferably act at the same time as support feet 71 for placing the transport container 3 down.

1-31. (canceled)

32. A working apparatus having a transportable work trestle,
wherein the work trestle has a support body defining an object support surface that extends in a longitudinal trestle direction, and two support leg structures that are mounted, or can be mounted, in a positionally variable manner on the support body at leg attachment interfaces arranged spaced apart from one another in the longitudinal trestle direction,
and wherein the work trestle can selectively be brought into a working configuration, allowing for its intended use, with the support leg structures extending transversely to the longitudinal trestle direction of the support body in a usage position, or into a transport configuration for transporting the work trestle, with the support leg structures moved into a non-usage position adjacent to the support body, wherein
the support body can be reconfigured to shorten the work trestle so that the distance between the two leg attachment interfaces in the transport configuration of the work trestle is smaller than in the working configuration,
and that the working apparatus has a transport container with an internal compartment, enabling the work trestle to be transported in its shortened transport configuration compared with the working configuration, wherein the transport container has at least one carrying handle that can be gripped for manual transport of the work trestle.

33. The working apparatus according to claim 32, wherein each support leg structure is detachably attached at its associated leg attachment interface to the support body, wherein, in the working configuration of the work trestle, the support leg structures are attached to the support body in their usage position, and in the transport configuration of the work trestle, they are removed from the support body to assume their non-usage position.

34. The working apparatus according to claim 32, wherein the transport container has two container elements positioned opposite one another in a container height direction and pivotable relative to one another to specify either a closed state sealing the internal container space or an open state providing access to the internal container space, wherein at least one carrying handle is arranged on the outside of one of the two container elements.

35. The working apparatus according to claim 34, wherein the transport container has a rectangular outline oriented transversely to the container height direction.

36. The working apparatus according to claim 32, wherein the transport container usable for transporting the work trestle is equipped with a coupling system, which is designed to allow the transport container and at least one additional storage container with a similar coupling system to be stacked on top of one another and to be detachably coupled in such a way that they form a unified, transportable container stack assembly that cannot be lifted apart.

37. The working apparatus according to claim 36, wherein the coupling system of the transport container has an upper coupling device arranged in the region of the container upper side oriented in the container height direction, and a lower coupling device arranged in the region of a container underside opposite the container upper side, wherein these upper and lower coupling devices allow the transport container and at least one additional storage container equipped with similar upper and lower coupling devices to be stacked on top of one another and detachably coupled to one another in such a manner that they cannot be lifted apart, forming a unified, transportable container stack assembly, and/or
wherein the working apparatus additionally includes at least one storage container which is equipped with a coupling system similar to that of the transport container, so that the transport container can be coupled to a storage container arranged on the transport container and/or to a storage container arranged under the transport container in a manner that prevents them from being lifted apart from one another to form a unified, transportable stack of containers.

38. The working apparatus according to claim 32, wherein the work trestle is a separate device component of the working apparatus with respect to the transport container, wherein, in the working configuration, the work trestle is separated from the transport container and can be used individually for its intended purpose, independent of the transport container, and wherein, in the transport configuration, the work trestle can be combined, or is combined, with the transport container into a transport unit that can be transported by gripping the at least one carrying handle.

39. The working apparatus according to claim 38, wherein the work trestle in its transport configuration can be placed, or is placed, inside the internal container space of the transport container to form the transport unit.

40. The working apparatus according to claim 39, wherein the transport container has two container elements positioned opposite one another in a container height direction and pivotable relative to one another to specify either a closed state sealing the internal container space or an open state providing access to the internal container space, wherein at least one carrying handle is arranged on the outside of one of the two container elements, wherein the transport container has a container base formed by one of the two container elements and a container lid formed by the other of the two container elements which is pivotably mounted on the container base, wherein the container lid is pivotable relative to the container base between a closed position where it seals and can be locked to secure the internal container space of the transport container and an open position where it provides access to the internal container space, allowing the work trestle in its transport configuration to be selectively inserted or removed, in which the transport container is in the open state.

41. The working apparatus according to claim 38, wherein the transport container has a holding structure on the outside, to which the work trestle in its transport configuration can be detachably attached or attached to form the transport unit.

42. The working apparatus according to claim 41, wherein the transport container has the at least one carrying handle on an upper side oriented in the container height direction, wherein the holding structure is arranged on an outer surface of the transport container oriented orthogonally to the container height direction, wherein the work trestle attached to the holding structure in the transport configuration only extends within the outline of the outer container surface provided with the holding structure.

43. The working apparatus according to claim 32, wherein the transport container is an immediately integral part of the work trestle, wherein the transport container forms the support body of the work trestle, wherein the transport container has two container elements that are pivotably fixed to one another, each forming one of the two support body elements of the support body, wherein in the working configuration of the work trestle, the two support body elements adopt an unfolded position, arranged consecutively in the longitudinal trestle direction, and in the transport configuration of the work trestle, a folded position arranged in a side-by-side orthogonally to the longitudinal trestle direction, wherein each support body element has one of the two leg attachment interfaces.

44. The working apparatus according to claim 43, wherein in the working configuration of the work trestle, the two leg attachment interfaces are spaced apart from one another in the longitudinal trestle direction and in the transport configuration of the work trestle, they are arranged side-by-side, transverse to the longitudinal trestle direction, wherein in the transport configuration of the work trestle the two leg attachment interfaces are at the same height in relation to the longitudinal trestle direction.

45. The working apparatus according to claim 43, wherein each of the two support body elements has two opposing axial end faces oriented in the longitudinal trestle direction, wherein in the consecutive position of the support body elements, one of the two axial end faces of one support body element faces one of the axial end faces of the other support body element and is adjacent thereto, wherein the two support body elements are pivotably fixed to one another in the region of the two end faces that face one another in the consecutive position by a hinge device defining a pivot axis orthogonal to the longitudinal trestle direction.

46. The working apparatus according to claim 43, wherein the support body in the side-by-side position has a maximum length extending in the longitudinal trestle direction, so that unfolding the support body elements results in a length extension of the support body in the longitudinal extent direction of the maximum length.

47. The working apparatus according to claim 43, wherein the two support body elements are pivotable relative to one another for changing between the side-by-side and the consecutive positions around a pivot axis that extends either in a horizontal transverse trestle direction orthogonal to the longitudinal trestle direction or in a vertical trestle height direction orthogonal to the longitudinal trestle direction.

48. The working apparatus according to claim 43, wherein each of the two support body elements has an object support surface section on its upper side oriented in a direction orthogonal to the longitudinal direction and the transverse direction of the trestle, wherein in the unfolded consecutive position of the two support body elements, the object support surface sections complement one another to form a strip-like object support surface extending in the longitudinal trestle direction, and wherein each object support surface section is formed on a replaceable support plate of the associated support body element and/or is provided with fastening structures for attaching external objects.

49. The working apparatus according to claim 48, wherein the object support surface sections of the two support body elements are located on outer sides of the two support body elements which lie next to one another in the side-by-side position of the two support body elements and face in the same direction or face away from one another in the side-by-side position of the two support body elements.

50. The working apparatus according to claim 43, wherein the support body has at least one securing device for the detachable, non-pivotable fixing of the two support body elements in both the side-by-side and consecutive positions, and/or
wherein each of the two support body elements has an open receiving recess on the side facing the other support body element in the side-by-side position which together define the internal container space, wherein each support body element has a shell-shaped design, and/or
wherein one of the two support body elements has at least one carrying handle on its outer side facing away from the other support body element in the side-by-side arrangement, wherein the other of the two support body element is provided on an outer side facing away from the other support body element in the side-by-side arrangement of the two support body elements with an integral support foot structure that can be used to place the transport unit on a surface.

51. The working apparatus according to claim 50, wherein the receiving recess of each support body element is divided into multiple storage compartments by at least one partition wall, so that the internal container space formed in the side-by-side position of the support body elements has multiple internal compartments, one of which forms the storage space for receiving the support leg structures in their non-usage position and at least one additional internal compartment is designed for storing auxiliary objects.
